(19) United States
(12) Patent Application Publication
(10) Pub. No.: US 2025/0386244 A1
(43) Pub. Date: Dec. 18, 2025

(54) Roaming Method and Station for Managing Uplink Data Transmission

(71) Applicant: MEDIATEK INC., Hsinchu City (TW)

(72) Inventor: Yang-Hung Peng, Hsinchu City (TW)

(73) Assignee: MEDIATEK INC., Hsinchu City (TW)

(21) Appl. No.: 19/226,188

(22) Filed: Jun. 3, 2025

Related U.S. Application Data
(60) Provisional application No. 63/660,595, filed on Jun. 17, 2024.

(51) Int. Cl. H04W 28/06; H04L 1/1607

(52) U.S. Cl. CPC H04W 28/06; H04L 1/1628

(57) ABSTRACT

A roaming method for managing uplink data transmission performed by a station includes transmitting a first set of packets from a transmitting queue of the station to a first access point, updating the transmitting queue, and transmitting a second set of packets from the updated transmitting queue to a second access point after roaming. The packets in the transmitting queue are identified by sequence numbers (SNs). All failed packets remaining in the transmitting queue that have SNs preceding the last ack SN are dropped for a roaming scenario. The second set of packets starts with a packet having an SN subsequent to the last ack SN. The last ack SN is defined as a specific SN of the last packet indicated as successfully received by the first access point.

### CROSS REFERENCE TO RELATED APPLICATIONS

This application claims the benefit of U.S. Provisional Application No. 63/660,595, filed on Jun. 17, 2024. The content of the application is incorporated herein by reference.

### BACKGROUND

In wireless communication technologies, a station roaming between a first access point (AP) and a second AP often experiences uplink traffic issues like packet duplication or out-of-order delivery to the Distribution System (DS). Ideally, data transmission is seamless, but degraded link quality during roaming frequently causes problems.

Out-of-order delivery occurs if the first AP fails to receive some packets. When the station roams and retransmits these to the second AP along with new data, the DS may receive packets in an incorrect sequence. Packet duplication arises if the station fails to receive acknowledgments from the first AP and retransmits all unacknowledged packets to the second AP. This leads to the DS receiving duplicate packets.

Conventional methods to address these issues have conceptual drawbacks. Some approaches can prevent retransmission to the second AP of data already sent to the first AP. However, such approaches can inadvertently lead to packet loss if the first AP never successfully received those initial transmissions. Other approaches rely on coordination between two APs to filter packets. While these approaches can reduce duplicates and out-of-order issues at the network level, they may still result in the station inefficiently retransmitting data that the second AP is predetermined to discard. Such redundant transmissions consume valuable wireless resources and can delay subsequent new data.

Therefore, a more efficient mechanism is required for managing uplink traffic during seamless roaming to eliminate packet duplication or out-of-order issues and improve resource utilization and latency reduction.

### SUMMARY

In an embodiment, a roaming method for managing uplink data transmission performed by a station is disclosed. The roaming method comprises transmitting a first set of packets from a transmitting queue of the station to a first access point, updating the transmitting queue, and transmitting a second set of packets from the updated transmitting queue to a second access point after roaming. The packets in the transmitting queue are identified by sequence numbers (SNs). All failed packets remaining in the transmitting queue that have SNs preceding the last ack SN are dropped for a roaming scenario. The second set of packets starts with a packet having an SN subsequent to the last ack SN. The last ack SN is defined as a specific SN of the last packet indicated as successfully received by the first access point.

In another embodiment, a station for managing uplink data transmission is disclosed. The station comprises a roaming control module, a transmitter module coupled to the roaming control module, a receiver module, and a queue management module coupled to the transmitter module and the receiver module. The transmitter module is configured to transmit a first set of packets from a transmitting queue managed by the queue management module to a first access point. The packets in the transmitting queue are identified by sequence numbers (SNs). The queue management module is configured to update the transmitting queue. All failed packets remaining in the transmitting queue that have SNs preceding the last ack SN are dropped for a roaming scenario. The transmitter module is further configured to transmit a second set of packets from the updated transmitting queue to a second access point after roaming. The second set of packets starts with a packet having an SN subsequent to the last ack SN. The last ack SN is defined as a specific SN of the last packet indicated as successfully received by the first access point.

The present disclosure introduces a roaming method and a station designed to manage uplink transmission more effectively during roaming between access points. By transmitting a first set of packets to a first access point and then identifying the last SN successfully acknowledged (the last ack SN), the station proactively updates its transmitting queue by dropping any remaining failed packets that have SNs preceding the last ack SN. Consequently, when the station begins transmitting a second set of packets to the second access point after roaming, it starts with the packet immediately subsequent to the last ack SN. This approach offers significant advantages by directly addressing packet duplication and out-of-order issues, thereby improving wireless resource utilization and reducing transmission latency compared to conventional methods.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a station for managing uplink data transmission according to an embodiment of the present disclosure.

FIG. 2 is a schematic diagram of a first roaming approach performed by the station in FIG. 1.

FIG. 3 is a schematic diagram of a second roaming approach performed by the station in FIG. 1.

FIG. 4 is a schematic diagram of a third roaming approach performed by the station in FIG. 1.

FIG. 5 is a schematic diagram of updating a transmitting queue of the station in FIG. 1.

FIG. 6 is a flow chart of performing a roaming method based on a roaming flag by the station in FIG. 1.

FIG. 7 is a flow chart of performing a method for managing uplink data transmission by the station in FIG. 1.

### DETAILED DESCRIPTION

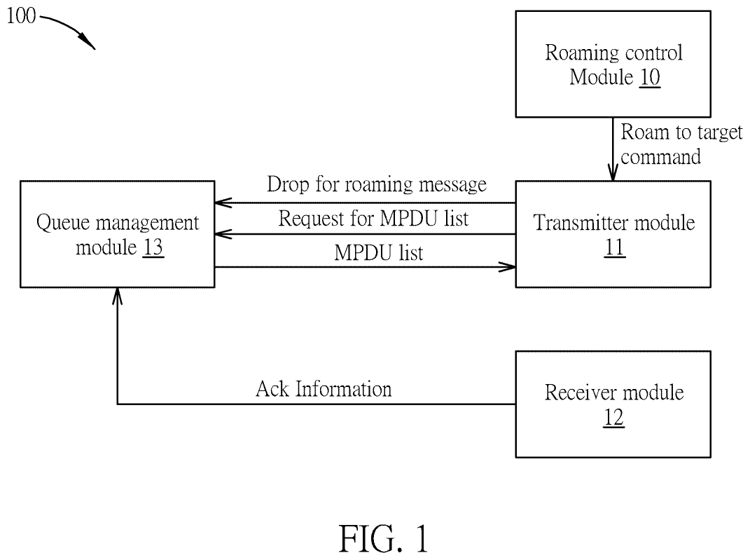

FIG. 1 is a block diagram of a station 100 for managing uplink transmission according to an embodiment of the present disclosure. The station 100 is designed to resolve common uplink issues of packet duplication and out-of-order delivery that occur when it roams between two access points (APs), leading to wasted bandwidth and increased transmission latency. In the embodiments, the advantage of station 100's “Ack Dependent” mechanism is its proactive optimization of the transmitting queue, significantly reducing redundant packets sent to a target AP. The key idea is to track the sequence number (SN) of the “last acknowledged packet” (also referred as last packet) indicated as successfully received by a source AP. For the convenience of explanation, the present disclosure refers to the specific SN of the “last acknowledged packet” as the last ack SN, that is, the last ack SN is defined as the specific SN of the last packet indicated as successfully received by the first access point. When preparing to roam to the target AP, the station 100's queue management module inspects the transmitting queue. It may drop the failed packet(s) earlier than the “last acknowledged packet” (i.e., all failed packets remaining in the transmitting queue that have SNs preceding the last ack SN are dropped for a roaming scenario), to update the transmitting queue. After the transmitting queue is updated, the station 100 begins transmission to the target AP starting with the packet immediately following the “last acknowledged packet”. The roaming mechanism, controlled by the station 100, involves processing ack information, recording the last acknowledged SN (i.e., the last ack SN), and executing additional packet-dropping operation for a roaming scenario. By doing so, the station 100 ensures a more streamlined transmission flow from the source AP to the target AP, effectively mitigating packet duplication and out-of-order problems.

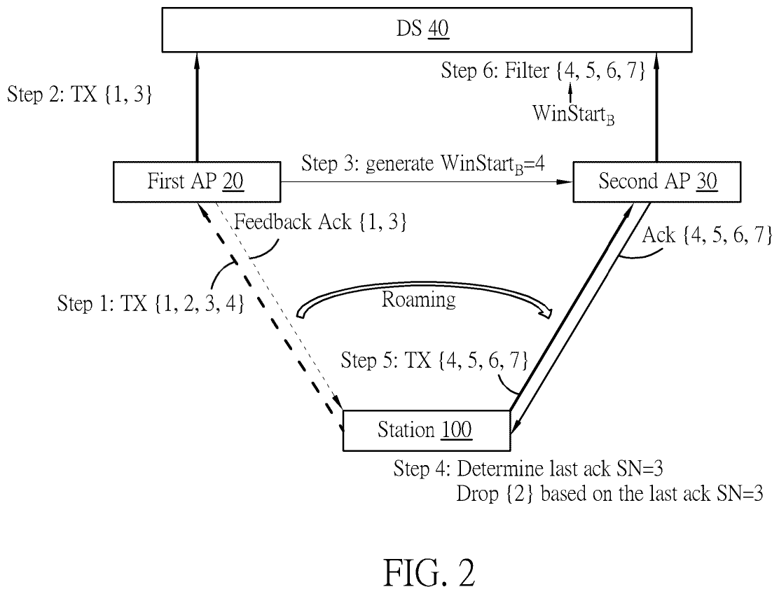

In FIG. 1, the station 100 includes a roaming control module 10, a transmitter module 11 coupled to the roaming control module 10, a receiver module 12, and a queue management module 13 coupled to the transmitter module 11 and the receiver module 12. In the station 100, “roaming” is a process where the station 100 transitions its wireless connection from a first AP 20 to a second AP 30 (as shown in FIG. 2 to FIG. 4), to maintain network connectivity as the station moves. For example, the station 100 sends its uplink traffic to the first AP 20. When the station 100 moves out of the network coverage of first AP 20 and into the network coverage of the second AP 30, the station 100 initiates a roaming process to switch its connection from the first AP 20 to the second AP 30.

In FIG. 1, the roaming control module 10 is configured to manage the roaming process of the station 100. When the station 100 needs to transition its wireless connection from a current (source) AP to a new (target) AP, the roaming control module 10 initiates and controls this roaming process. As depicted in FIG. 1, the roaming control module 10 can send a “roam to target AP command” to the transmitter module 11, signaling that subsequent transmissions of the transmitter module 11 should be directed towards the target AP. The transmitter module 11 is coupled to the roaming control module 10 and the queue management module 13. The transmitter module 11 is configured to transmit packets. For the packet transmission, the transmitter module 11 sends a request for MPDU list (MAC Protocol Data Unit list) to the queue management module 13. In response, the transmitter module 11 receives an “MPDU list” from the queue management module 13, which contains the packet list to be transmitted. In addition, after receiving the “roam to target AP command”, the transmitter module 11 can also send a “Drop for roaming message” to the queue management module 13, informing the queue management module 13 to discard (i.e., drop) certain packets to prevent issues like duplication or out-of-order delivery at network side. The receiver module 12 is configured to receive signals from the APs. The receiver module 12 can send “ack information” to the queue management module 13. For example, the “ack information” received in the form of acknowledgment (ack) or block ack (BA) signals, indicates which packets have been successfully received by the source AP. The queue management module 13 is configured to manage the transmitting queue of the station 100, where the packets (e.g., MPDUs) are buffered in the transmitting queue before transmission. Based on the “ack information”, the queue management module 13 updates the status of packets in the transmitting queue, for instance, by releasing packets that have been successfully received/acknowledged. Further, based on the “drop for roaming message” transmitted from the transmitter module 11, the queue management module 13 further updates the transmitting queue by dropping the failed packets with SNs preceding the last ack SN) to optimize transmission to the target AP after roaming. Understandably, the failed packets may be referred to the packets not successfully received by the source AP. Further, when the transmitter module 11 sends a request for MPDU list, the queue management module 13 provides the relevant list of MPDUs for transmission to the transmitter module 11.

In brief, for the station 100, the transmitter module 11 is configured to transmit a first set of packets from the transmitting queue managed by the queue management module 13 to the first AP. The packets in the transmitting queue are identified by SNs. The queue management module 13 is configured to update the transmitting queue, wherein all failed packets remaining in the transmitting queue that have SNs preceding the last ack SN are dropped for a roaming scenario. The transmitter module 11 is configured to transmit a second set of packets from the updated transmitting queue to the second AP after roaming. The second set of packets start with a packet having an SN subsequent to the last ack SN. The last ack SN is defined as a specific SN of the last packet indicated as successfully received by the first AP. For example, the last packet may be any packet in the first set of packets, or any packet transmitted earlier. For convenience, the following embodiments are described by taking one packet in the first set of packets as an example of the last packet indicated as successfully received by the first AP, and the first AP is regarded as the source AP. The second AP is regarded as the target AP, hereafter.

Details of various roaming approaches are illustrated below.

FIG. 2 is a schematic diagram of a first roaming approach performed by the station 100. In this scenario, the station 100, the first AP 20, the second AP 30, and a distribution system (DS) 40 are introduced. The first roaming approach includes step 1 to step 6, as illustrated below. In step 1, the station 100 transmits a first set of packets from its transmitting queue to the first AP 20. In one embodiment, the first set of packets may comprise a plurality of MAC Protocol Data Units (MPDUs), each with its sequence number, wherein the MPDUs may be aggregated into at least one Physical Layer Convergence Procedure (PLCP) Protocol Data Units (PPDU). each PPDU including MPDUs is then transmitted as a single unit to the first AP 20. However, to maintain generality, the embodiments are described using the term “packets” rather than the more specific “MPDUs”. The rationale behind this choice is that the disclosure is not intended to be limited exclusively to Wi-Fi scenarios. Therefore, employing the term “packets” provides a broader scope of applicability, encompassing various wireless communication technologies where sequenced units of packets are transmitted, without restricting the disclosure to the specific frame structures or protocols of Wi-Fi. For example, in the embodiment, the first set of packets are identified by sequence numbers (SNs) {1, 2, 3, 4}. The first AP 20 may successfully receive a portion of the first set of packets, for example, the packets {1, 3}. The first AP 20 then sends an ack signal {1, 3} back to the station 100, indicating that packets with SN=1 and SN=3 have been successfully received.

Subsequently, in step 2, the first AP 20 may transmit the successfully received packets {1, 3} to the DS 40, because the station starts the roaming process. In step 3, concurrently with or after step 2, the first AP 20 can generate a window start indicator WinStart_{B}, for example, “WinStart_{B}=4”. The window start indicator WinStart_{B} is defined as an SN subsequent to the ack SN, for example, the specific SN of the last packet among at least one packet in the first set of packets indicated as successfully received by the first AP 20 (e.g., (the last ack SN is 3 from the set {1, 3}, so WinStart_{B}=3+1=4). The first AP 20 transmits the window start indicator “WinStart_{B}=4” to the second AP 30. The window start indicator is useful to assist the second AP 30 in managing packet ordering or filtering. Understandably, the window start indicator WinStart_{B} is used to indicate the starting sequence number of the receive buffer to the second AP 30. In the embodiment, WinStart_{B}=the last ack SN+1.

In step 4, upon receiving the ack signal {1, 3} from the first AP 20, the station 100 (for example, the queue management module 13) determines that the “last ack SN” is 3 and then buffers/stores the last ack SN. As previously mentioned, the last ack SN is defined as a specific SN of the last packet among data packets of the first set indicated as successfully received by the first access point (e.g., the specific SN of the last packet in the packets {1, 3} successfully received is “3”, defined as the last ack SN). Before performing transmission to the second AP 30 after roaming, the station 100 updates its transmitting queue. The transmitting queue's updating process involves dropping any failed packets remaining in the transmitting queue that have SNs preceding the determined “last ack SN”. Understandably, the failed packets were not acknowledged by the first AP 20. For example, the packet {2} was transmitted but not acknowledged, and its SN precedes the last ack SN (last ack SN=3), hence, the packet {2} is a failed packet. Therefore, the station 100 drops the packet {2} for the roaming scenario. It should be understood that the queue management module 13 is also configured to release at least one packet in the first set of packets from the transmitting queue after the at least one packet in the first set of packets is successfully received by the first AP 20. For example, the packets {1, 3} are successfully received and are released from the transmitting queue. Following the roaming process, the station 100 transitions its connection from the first AP 20 to the second AP 30.

In step 5, the station 100 transmits a second set of packets, {4, 5, 6, 7}, from its updated transmitting queue to the second AP 30. Notably, the second set of packets starts with a packet (SN=4) that has an SN subsequent to the “last ack SN=3”. In an exemplary embodiment, the second AP 30 successfully receives these packets {4, 5, 6, 7} and sends an ack signal {4, 5, 6, 7} back to the station 100, to indicate that the packets with SNs {4, 5, 6, 7} was successfully received. In step 6, the second AP 30 using the previously received window start indicator WinStart_{B} (for example, “WinStart_{B}=4”), filters the received packets {4, 5, 6, 7} and forwards them to the DS 40. In the embodiment, since the window start indicator WinStart_{B} points to SN=4, no packet having SN<4 in the packets {4, 5, 6, 7} needs to be dropped by the second AP 30. As a result, the second set of packets {4, 5, 6, 7} are entirely forwarded to the DS 40.

In FIG. 2, the first roaming approach manages the transmitting queue based on the ack signal received from the first AP 20 to reduce redundant transmissions and out-of-order issues when roaming from the first AP 20 to the second AP 30.

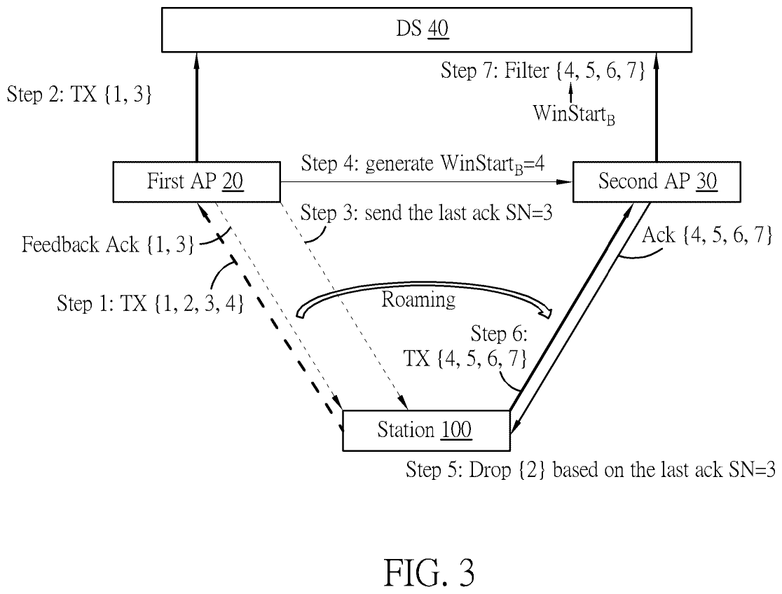

FIG. 3 is a schematic diagram of a second roaming approach performed by the station 100. In this scenario, the station 100, the first AP 20, the second AP 30, and the DS 40 are introduced. The second roaming approach includes Step 1 to Step 7, as illustrated below. In Step 1, the station 100 transmits a first set of packets, identified by sequence numbers (SNs), as {1, 2, 3, 4}, from its transmitting queue to the first AP 20. In the example as shown by FIG. 3, the first AP 20 may successfully receive a portion of the first set of packets, such as the packets {1, 3}. The first AP 20 then sends an ack signal {1, 3} back to the station 100, indicating that packets with SN=1 and SN=3 have been successfully received. Subsequently, in Step 2, the first AP 20 may transmit the successfully received packets {1, 3} to the DS 40, because the station starts the roaming process. In Step 3, the first AP 20 determines the last ack SN from the packets it successfully received, which in this embodiment is SN=3. The first AP 20 then transmits an indication of the last ack SN (for example, the “last ack SN=3” information) to the station 100. The station 100 (for example, the receiver module 12) receives the indication of the last ack SN (for example, “last ack SN=3”). In Step 4, concurrently with or after Step 3, the first AP 20 can generate a window start indicator WinStart_{B}, for example, “WinStart_{B}=4”. Similarly, the window start indicator WinStart_{B} is defined as an SN subsequent to the last ack SN (i.e., equaling to the last ack SN plus 1, e.g., the last ack SN is 3, so WinStart_{B}=3+1=4). The first AP 20 transmits the window start indicator “WinStart_{B}=4” information to the second AP 30. The window start indicator is useful to assist the second AP 30 in managing packet ordering or filtering.

In Step 5, upon receiving the indication of the last ack SN (for example, “last ack SN=3”) from the first AP 20, the station 100 updates its transmitting queue. The queue management module 13 updates and buffers the last ack SN. The transmitting queue's updating process involves dropping any packets remaining in the transmitting queue that have SNs preceding the “last ack SN” and were not acknowledged. For example, the packet {2} is dropped because its SN precedes the last ack SN=3 and was not part of the acknowledged packets {1, 3}. As previously mentioned, the packets {1, 3} that were successfully acknowledged would be released from the transmitting queue of the station 100 upon receipt of the “ack signal {1, 3}”.

After roaming, in Step 6, the station 100 transmits a second set of packets with SNs {4, 5, 6, 7} from its updated transmitting queue to the second AP 30. Notably, the second set of packets start with a packet (SN=4) that has an SN subsequent to the “last ack SN=3”. The second AP 30 successfully receives these packets {4, 5, 6, 7} and sends an ack signal {4, 5, 6, 7} back to the station 100. In Step 7, the second AP 30 using the previously received window start indicator WinStart_{B} (such as “WinStart_{B}=4”), filters the received packets {4, 5, 6, 7} and forwards them to the DS 40. In the embodiment, since the window start indicator WinStart_{B} points to SN=4, no packet having SN<4 among the received packets {4, 5, 6, 7} needs to be dropped. As a result, the second set of packets {4, 5, 6, 7} are entirely forwarded to the DS 40.

The distinction between the roaming approaches illustrated in FIG. 2 and FIG. 3 lies in the method by which the station 100 obtains the “last ack SN” used to update its transmitting queue before performing transmission to the second AP 30 after roaming. In the first roaming approach depicted in FIG. 2, the station 100 autonomously determines the last ack SN by interpreting the ack signal received from the first AP 20. In the second roaming approach depicted in FIG. 3, the station 100 receives the last ack SN explicitly from the first AP 20. Both embodiments ensure that the station 100 updates its transmitting queue by further dropping failed packets with SNs preceding the last ack SN, thereby optimizing uplink data transmission.

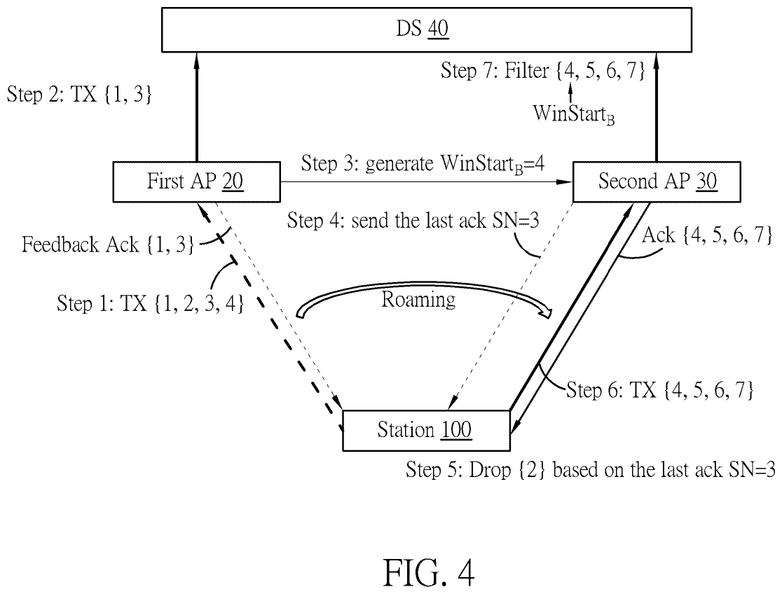

FIG. 4 is a schematic diagram of a third roaming approach performed by the station 100. In this scenario, the station 100, the first AP 20, the second AP 30, and the DS 40 are introduced. The third roaming approach includes Step 1 to Step 7, as illustrated below. In Step 1, the station 100 transmits a first set of packets, identified by sequence numbers (SNs) {1, 2, 3, 4}, from its transmitting queue to the first AP 20. The first AP 20 successfully receives a portion of the first set of packets, such as the packets {1, 3}. The first AP 20 then sends an ack signal {1, 3} back to the station 100, indicating that packets with SN=1 and SN=3 have been successfully received. Subsequently, in Step 2, the first AP 20 may transmit the successfully received packets {1, 3} to the DS 40, because the station starts the roaming process. In Step 3, concurrently with or after Step 2, the first AP 20 can generate a window start indicator WinStart_{B}, for example, “WinStart_{B}=4”. The window start indicator WinStart_{B} is defined as an SN subsequent to the last SN among the at least one data packet in the first set of packets indicated as successfully received by the first AP 20 (i.e., the last SN plus 1, e.g., (the last SN is 3 in the set of successfully received packets {1, 3}, so WinStart_{B}=3+1=4). The first AP 20 transmits the window start indicator (for example, “WinStart_{B}=4”) to the second AP 30. The window start indicator is useful to assist the second AP 30 in managing packet ordering or filtering.

In step 4, the second AP 30 determines and sends the “last ack SN=3” to the station 100. The second AP 30 explicitly transmit an indication of the last ack SN, to inform the station 100 of the sequence number of the last packet that the first AP 20 successfully acknowledged from the first set of data packets. Especially, in the second AP 30, after the window start indicator WinStart_{B} is received, the last ack SN can be derived from the window start indicator WinStart_{B} by decreasing one, such as

$$last ack SN = {WinStart}_{B} - 1$$

In step 5, upon receiving the indication of the last ack SN (for example, “last ack SN=3”) from the second AP 30, and as the station 100 undergoes roaming, the queue management module 13 updates the transmitting queue. The transmitting queue's updating process involves dropping any packets remaining in the transmitting queue that have SNs preceding the “last ack SN” and were not themselves acknowledged. For example, the packet {2} is dropped because its SN precedes the last ack SN=3 and was not part of the acknowledged packets {1, 3}. As previously mentioned, the packets {1, 3} that were successfully received/acknowledged would be released from the transmitting queue of the station 100 upon receipt of the “ack signal {1, 3}”.

In step 6, after roaming to the second AP 30 and updating the transmitting queue, the station 100 transmits a second set of packets {4, 5, 6, 7} from its updated transmitting queue to the second AP 30. The second set of packets start with a packet (SN=4) having an SN subsequent to the “last ack SN=3”. The second AP 30, upon receiving the second set of packets {4, 5, 6, 7}, sends an ack signal {4, 5, 6, 7} back to the station 100 for indicating that the packets with SNs {4, 5, 6, 7} are successfully received. In step 7, the second AP 30 filters the received packets {4, 5, 6, 7} based on the previously received window start indicator “WinStart_{B}=4”. In the embodiment, since the packets start at SN=4, which matches the WinStart_{B}, no packet among the packets {4, 5, 6, 7} needs to be dropped. As a result, the second set of packets {4, 5, 6, 7} are entirely forwarded to the DS 40.

The third roaming approach in FIG. 4 provides an alternative method for deriving the last ack SN based on the window start indicator WinStart_{B} received by the second AP 30. In the embodiments in FIG. 2 to FIG. 4, the station 100 updates its transmitting queue by identifying the last ack SN corresponding to the last packet successfully received/acknowledged by the first AP 20. The station 100 then drops any unacknowledged/failed packets remaining in its transmitting queue that have SNs preceding the last ack SN. Subsequently, when transmitting to the second AP 30 after roaming, the station 100 commences with a packet having an SN immediately subsequent to the last ack SN. This proactive packet dropping and sequential transmission mechanism by the station 100 can prevent the retransmission of packets that were likely already processed by the first AP 20 (even if their acknowledgments were lost) or that would otherwise arrive at the DS out of order.

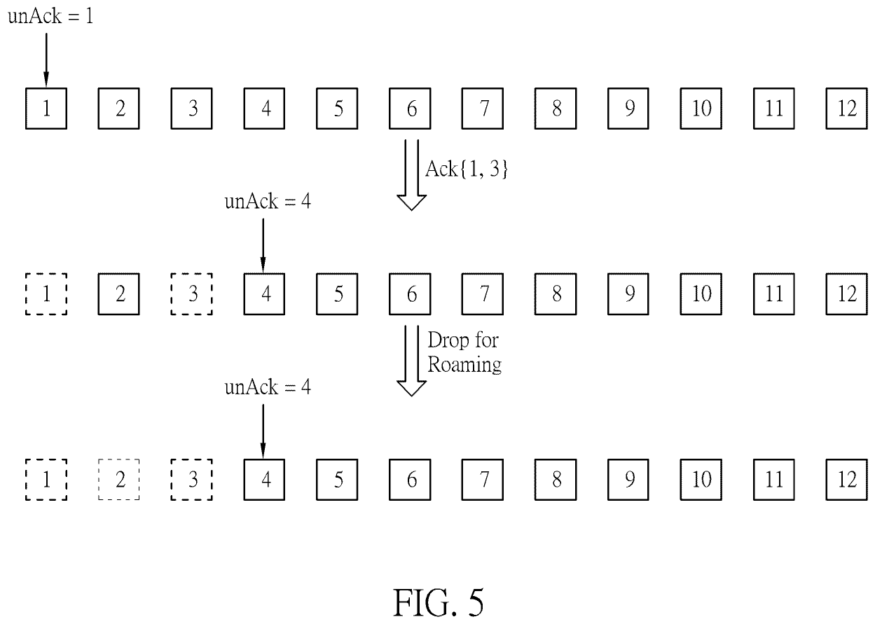

FIG. 5 is a schematic diagram of updating a transmitting queue of the station 100. FIG. 5 illustrates a sequence of operations performed on the transmitting queue of packets, each identified by a sequence number (SN). Initially, the transmitting queue contains packets with SNs from 1 to 12. For convenience, a pointer labeled “unAck” is set to 1, indicating that no packets have been acknowledged yet. When an Ack or Block Ack (BA) is received, the acknowledged MPDU is freed (i.e., released) and the unAck pointer is updated to

$$unAck = last ack SN + 1 , if last ack SN \geq unAck$$

For example, in the first operation, an ack signal, “Ack {1, 3}”, is received. The ack signal signifies that packets with SN=1 and SN=3 have been successfully received. Consequently, these acknowledged packets (SN=1 and SN=3) are processed or freed from the transmitting queue. Further, the “unAck” pointer is then updated. Based on the received ack signal, the last ack SN is determined to 3. Therefore, the “unAck” pointer advances to SN=3+1=4, which is the sequence number immediately following the last ack SN.

Following the first operation, a “Drop for Roaming” process is executed. The “Drop for Roaming” process targets packets in the transmitting queue that precede the last ack SN or the current “unAck” pointer (unAck=4) and have not been successfully acknowledged. In the embodiment, a packet with SN=2 is not acknowledged (as only SN=1 and SN=3 are in the “Ack {1, 3}” signal) and its SN is less than 4. Therefore, the packet with SN=2 is dropped from the transmitting queue. That is to say, all failed packets remaining in the transmitting queue that have SNs preceding the last ack SN are dropped for a roaming scenario. The “unAck” pointer remains at 4. The final state of the transmitting queue shows the packets with SN=1 and SN=3 as processed/freed, the packet with SN=2 as dropped, and the packets from SN=4 onwards remaining in the transmitting queue for potential future transmission. Understandably, the “unAck” pointer is equal to the window start indicator WinStart_{B}.

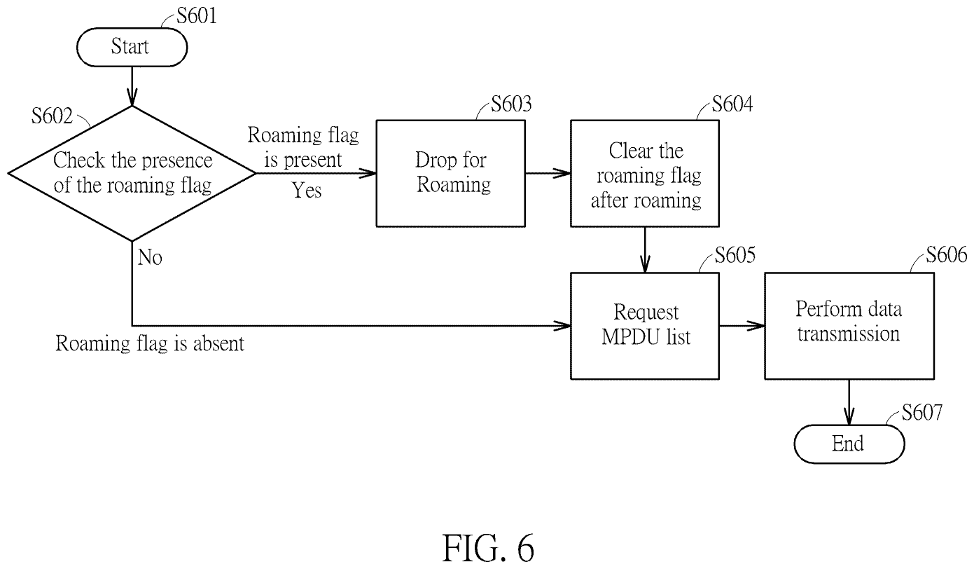

FIG. 6 is a flow chart of performing a roaming method based on a roaming flag by the station 100. FIG. 6 includes steps S601 to S607. Any technology or hardware modification falls into the scope of the present disclosure. Steps S601 to S607 are illustrated below.
Step S601: Process start;
Step S602: Checking the presence of the roaming flag, if the roaming flag is absent, go to step S605, if the roaming flag is present, go to step S603;
Step S603: Performing the drop for roaming process;
Step S604: Clearing the roaming flag after roaming;
Step S605: Requesting MPDU list;
Step S606: Performing data transmission;
Step S607: Process end.

The process starts at step S601. In step S602, the station 100 checks for the presence of a roaming flag. The roaming flag is set by the station 100 before transmitting the second set of packets to the second AP 30 during the roaming procedure. If the roaming flag is present (e.g., indicating that roaming-specific actions are required), the method proceeds to step S603. In step S603, the drop for roaming process is performed. The drop for roaming process, as mentioned previously, involves updating the transmitting queue by dropping certain failed packets remaining in the transmitting queue that have SNs preceding the “last ack SN”. Following the drop for roaming process, in step S604, the roaming flag is cleared by the station 100, signifying that the necessary transmitting queue adjustments for a roaming scenario have been completed. Therefore, the process then moves to step S605.

If the roaming flag is absent (e.g., indicating a normal transmission scenario or that roaming-specific queue adjustments have already been handled) in step S602, the method bypasses steps S603 and S604 and directly proceeds to step S605. In step S605, the transmitter module 11 sends a request for MPDU list to the queue management module 13. The MPDU list includes the packets (for example, the second set of packets) to be transmitted from the transmitting queue (may be updated in step S603). The station 100 obtains the MPDU list to determine a second set of packets from the updated transmitting queue. Subsequently, in step S606, the transmitter module 11 of the station 100 performs data transmission based on the obtained MPDU list. The process is completed at step S607. The roaming method in FIG. 6 ensures that the transmitting queue is appropriately managed before transmitting packets to a new AP after roaming, particularly by selectively dropping packets based on the last ack SN.

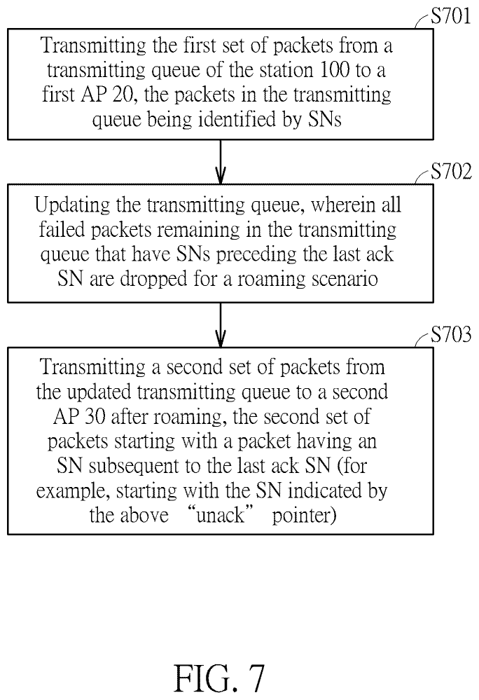

FIG. 7 is a flow chart of performing a method for managing uplink transmission by the station 100. FIG. 7 includes steps S701 to S703. Any technology or hardware modification falls into the scope of the present disclosure. Steps S701 to S703 are illustrated below.
Step S701: transmitting the first set of packets from a transmitting queue of the station 100 to a first AP 20, the packets in the transmitting queue being identified by SNs;
Step S702: updating the transmitting queue, wherein all failed packets remaining in the transmitting queue that have SNs preceding the last ack SN are dropped for a roaming scenario;
Step S703: transmitting a second set of packets from the updated transmitting queue to a second AP 30 after roaming, the second set of packets starting with a packet having an SN subsequent to the last ack SN (for example, starting with the SN indicated by the above “unack” pointer).

Details of steps S701 to S703 are previously illustrated. Thus, they are omitted here. The station 100 is designed to resolve uplink packet duplication and out-of-order delivery during roaming by proactively optimizing its transmission queue. The station 100 tracks the SN of the last successfully acknowledged packet, i.e., the above mentioned the last ack SN. When roaming is required, the queue management module 13 of the station 100 drops unacknowledged packets with SNs earlier than the last acknowledged one. Transmission to the new AP then starts with the packet immediately following the last ack SN. The method in FIG. 7 involves processing acknowledgments, recording the last ack SN, and executing the packet-dropping operation, ensuring streamlined transmission flow and mitigating duplication and out-of-order issues of roaming.

In summary, the embodiments disclose a roaming method and a station for managing uplink transmission. The key idea involves the station proactively optimizing its transmitting queue during roaming between APs. This is achieved by the station identifying the last ack SN for packet successfully received by the first AP. Further, the station then drops failed packets in its transmitting queue with SNs preceding the last ack SN. Then, the station transmits a second set of packets to the second AP, starting with a packet whose SN is subsequent to (after/behind) the last ack SN. The roaming method of the embodiments significantly mitigates packet duplication and out-of-order delivery, leading to improved wireless resource utilization and reduced latency compared to traditional methods, which often result in wasteful retransmissions or packet loss. As a result, the embodiments are broadly applicable to wireless environments where stations roam, such as Wi-Fi networks, ensuring streamlined transmission flow.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A roaming method for managing uplink transmission performed by a station comprising:
transmitting a first set of packets from a transmitting queue of the station to a first access point, wherein the packets in the transmitting queue are identified by sequence numbers (SNs);
updating the transmitting queue, wherein all failed packets remaining in the transmitting queue that have SNs preceding the last ack SN are dropped for a roaming scenario; and
transmitting a second set of packets from the updated transmitting queue to a second access point after roaming, wherein the second set of packets starts with a packet having an SN subsequent to the last ack SN;
wherein the last ack SN is defined as a specific SN of the last packet indicated as successfully received by the first access point.

2. The method of claim 1, wherein the first set of packets comprises a plurality of MAC Protocol Data Units (MPDUs) that are aggregated within at least one Physical Layer Convergence Procedure (PLCP) Protocol Data Unit (PPDU) transmitted to the first access point.

3. The method of claim 1, further comprising:
releasing at least one packet in the first set of packets from the transmitting queue by the station after the at least one packet in the first set of packets is successfully received by the first access point.

4. The method of claim 1, further comprising:
receiving an acknowledgment (ack) signal by the station from the first access point;
wherein the ack signal indicates at least one packet in the first set of packets being successfully received by the first access point.

5. The method of claim 4, wherein the last ack SN is determined by the station based on the ack signal.

6. The method of claim 4, further comprising:
receiving an indication of the last ack SN by the station from the first access point, wherein the last ack SN is determined by the first access point based on the at least one packet indicated as successfully received.

7. The method of claim 1, further comprising:
receiving an indication of the last ack SN by the station from the second access point, wherein the last ack SN is determined based on a window start indicator WinStart_{B}.

8. The method of claim 7, wherein a value of the window start indicator WinStart_{B} is equal to a value of the last ack SN plus 1.

9. The method of claim 1, further comprising:
setting a roaming flag by the station before transmitting the second set of packets to the second access point, to perform a drop operation for the roaming scenario during updating the transmitting queue; and
clearing the roaming flag by the station after updating the transmitting queue.

10. The method of claim 1, further comprising:
obtaining a MAC Protocol Data Units (MPDU) list by the station to determine the second set of packets from the updated transmitting queue.

11. A station for managing uplink transmission comprising:
a roaming control module;
a transmitter module coupled to the roaming control module;
a receiver module; and
a queue management module coupled to the transmitter module and the receiver module;
wherein the transmitter module is configured to transmit a first set of packets from a transmitting queue managed by the queue management module to a first access point, the packets in the transmitting queue are identified by sequence numbers (SNs), the queue management module is configured to update the transmitting queue, wherein all failed packets remaining in the transmitting queue that have SNs preceding the last ack SN are dropped for a roaming scenario, the transmitter module is further configured to transmit a second set of packets from the updated transmitting queue to a second access point after roaming, wherein the second set of packets starts with a packet having an SN subsequent to the last ack SN, and the last ack SN is defined as a specific SN of the last packet indicated as successfully received by the first access point.

12. The station of claim 11, wherein the first set of packets comprises a plurality of MAC Protocol Data Units (MPDUs) that are aggregated within at least one Physical Layer Convergence Procedure (PLCP) Protocol Data Unit (PPDU) transmitted to the first access point.

13. The station of claim 11, wherein the queue management module is further configured to release at least one packet in the first set of packets from the transmitting queue after the at least one packet in the first set of packets is successfully received by the first access point.

14. The station of claim 11, wherein the receiver module is configured to receive an acknowledgment (ack) signal from the first access point, and the ack signal indicates at least one packet in the first set of packets being successfully received by the first access point.

15. The station of claim 14, wherein the last ack SN is determined by the queue management module based on the ack signal.

16. The station of claim 14, wherein the receiver module is configured to receive an indication of the last ack SN from the first access point, and the last ack SN is determined by the first access point based on the at least one packet indicated as successfully received.

17. The station of claim 11, wherein the receiver module is further configured to receive an indication of the last ack SN from the second access point, and wherein the last ack SN is determined based on a window start indicator WinStart_{B}.

18. The station of claim 17, wherein a value of the window start indicator WinStart_{B} is equal to a value of the last ack SN plus 1.

19. The station of claim 11, wherein a roaming flag is set before transmitting the second set of packets to the second access point, to perform a drop operation for the roaming scenario during the update of the transmitting queue, and the roaming flag is cleared after updating the transmitting queue.

20. The station of claim 11, wherein the queue management module is further configured to provide a MAC Protocol Data Units (MPDU) list to the transmitter module to determine the second set of packets from the updated transmitting queue.
